(19) United States
(12) Patent Application Publication
(10) Pub. No.: US 2024/0226825 A9
(43) Pub. Date: Jul. 11, 2024

(54) METHOD AND COLLOIDAL MIXER FOR COLLOIDAL PROCESSING OF A SLURRY

(71) Applicant: BAUER MAT Slurry Handling Systems Zweigniederlassung der BAUER Maschinen GmbH, Immenstadt-Seifen (DE)

(72) Inventor: Rolf DÄUMLER, Burgberg (DE)

(73) Assignee: BAUER MAT Slurry Handling Systems Zweigniederlassung der BAUER Maschinen GmbH, Immenstadt-Seifen (DE)

(21) Appl. No.: 18/491,227

(22) Filed: Oct. 20, 2023

(30) Foreign Application Priority Data
Oct. 20, 2022 (EP) 22 202 720.3

(51) Int. Cl. B01F 25/50; B01F 23/00; B01F 23/50; B01F 23/53; B01F 27/112

(52) U.S. Cl. CPC B01F 25/50; B01F 23/023; B01F 23/51; B01F 23/53; B01F 27/112; B01F 2101/28

(57) ABSTRACT

The invention relates to a method and a colloidal mixer for colloidal processing of a slurry, in particular processing of construction materials, with a colloidal mixer, in which at least one liquid is introduced into a mixing trough, at the lower region of which is arranged an outlet opening with a mixing device having a mixing rotor, which is driven in rotation.

According to the invention, the at least one pulverulent solid component is introduced into the mixing trough, the at least one liquid mixed with the at least one pulverulent solid component is induced to flow by the rotatingly driven mixing rotor and is discharged from the mixing trough through the outlet opening, wherein the mixture is led back again for a certain time via a backflow line into an upper region of the mixing trough for further mixing and, after a desired mixing state has been attained, the mixture is discharged as a finished slurry from the outlet opening by means of a discharge line.

According to the invention, it is provided that air is incorporated into the at least one liquid and/or the mixture in a targeted manner in a finely dispersed form, wherein a relative density of the liquid, or of the mixture, is reduced.

The invention relates to a method for colloidal processing of a slurry, in particular processing of construction materials, with a colloidal mixer, in which at least one liquid is introduced into a mixing trough, at the lower region of which is arranged an outlet opening with a mixing device having a mixing rotor, which is driven in rotation, at least one pulverulent solid component is introduced into the mixing trough, the at least one liquid is mixed with the at least one pulverulent solid component by means of the rotationally driven mixing rotor, is induced to flow and is discharged from the mixing trough through the outlet opening, wherein the mixture is returned again for a certain time via a recirculation line to upper region of the mixing trough for further mixing and, after a desired mixing state has been attained, the mixture is discharged as a finished slurry from the outlet opening by means of a discharge line, according to the preamble of claim 1.

The invention further relates to a colloidal mixer for the colloidal processing of a slurry, in particular for the processing of construction materials and in particular for carrying out a method according to the invention, comprising a mixing trough which has an upper feed opening for feeding at least one liquid and at least one pulverulent solid component and a lower outlet opening, a mixing device which has a mixing rotor which can be driven in rotation and is arranged in a lower region of the mixing trough, wherein the at least one liquid and the at least one pulverulent solid component are mixed by the mixing rotor into a mixture and a flow of the at least one liquid or of the mixture can be generated towards the outlet opening, a recirculation line which extends from the outlet opening back again to the upper feed opening of the mixing trough, a discharge line for discharging a finished slurry from the mixing trough, and a control valve device by means of which the recirculation line and the discharge line can be opened or closed, in particular alternately, according to the preamble of claim 7.

A colloidal mixer for the colloidal processing of a slurry, in particular for the processing of construction materials, is for example disclosed in EP 2 363 200 B1.

The slurries prepared using these colloidal mixers consist of one or more liquid components, usually water, and one or more mostly mineral solid components, such as cement, bentonite, stone dust, fly ash, etc.

The use of such colloidally decomposed slurries is applied in a wide variety of industrial fields, such as in special civil engineering, mining, building rehabilitation, tunneling, mining, exploration for mineral resources and many more.

Initially, continuous colloidal mixers were developed, each of which could process only one liquid and one solid component.

These slurry mixers are mainly used in diaphragm wall construction, for the production of supporting liquids (bentonite slurry), but also for cut-off wall slurries in the single-phase diaphragm wall method.

In the course of newly developed construction processes, new requirements arose for the slurry qualities. Slurries composed of several liquid and solid components were also required.

As a result, the solids content in the mixing formulations exceeds the liquid content by a multiple, and slurry densities of 2 kg/dm³ and above are required. The available batch mixing systems are reaching their performance limits. In particular, so-called turbo mixers (mixing pumps) or circulation systems with Venturi nozzles are no longer capable of reliably and economically producing these required slurries in the required mixing quality.

Pulverulent solids have a very large surface area, depending on the fineness of crushing, and tend to form lumps (agglomerates) when wetted with liquid.

Depending on the loading condition of the mixing vessel and the density of the slurry already formed in the mixing system, these lumps begin to float on the surface of the slurry being in the mixing vessel and are hardly decomposed or not decomposed at all.

This leads to slurries of poor quality, where important parameters in view of rheology are not achieved.

The reduction of undesirable condition by installing additional rotating tools in the mixing vessel by breaking up these agglomerates is known. The disadvantage, however, is that the mixers are structurally complex and material in the form of incrustations accumulates on these additional tools, leading to extreme caking, especially with solids containing binders. This results in considerably higher cleaning and maintenance effort.

Another well-known method is to increase the circulation flow. This method increases the kinetic flow energy. This leads indeed to a partial, but not complete dissolution of agglomerates. The disadvantage here is also that part of the kinetic energy is introduced into the slurry in the form of heat, which is undesirable in some cases and can have negative impacts on hydration, for example, in particular in the case of cement.

The object underlying the invention is to specify a process and a colloidal mixer by means of which colloidal processing of a slurry can be carried out in a particular efficient and cost-saving manner.

This object is achieved on the one hand by a method having the features of claim 1 and on the other hand by a colloidal mixer having the features of claim 7. Preferred embodiments of the invention are indicated in the dependent claims.

The method according to the invention is characterized in that air is selectively incorporated into the at least one liquid and/or the mixture in finely dispersed form, wherein a relative density of the liquid or the mixture is reduced.

A basic idea of the invention is to reduce a relative density of the liquid or the mixture during the production of the mixture in a targeted manner by incorporating air in finely-dispersed form into the liquid or the mixture. This has the effect that pulverulent solids, which are located on the surface of the liquid or the mixture, sink faster and more reliably and thus no longer float on the surface of the liquid, in particular, if the mixture has an increased density due to additives. This causes extensive wetting of the pulverulent solid particles and these can be absorbed more quickly in the liquid/mixture and processed to form the colloidal slurry. Overall, a rapid production of a colloidal slurry with high mixing quality can thus be achieved in a particularly efficient manner without the provision of a large number of additional mixing tools. Due to a faster sinking of the solid components, they enter in the area of the mixing device earlier, which results in faster and better mixing. Conglomerates can be broken up efficiently.

The adjustment of the relative density of the mixture by incorporating air depends in each individual case on the formulation and on the liquid and solid components used. According to a further development of the invention, it is particularly advantageous that the relative density of the at least one liquid or of the mixture is reduced, wherein the volume of the liquid or of the mixture is increased by 2 percent to 15 percent by supplying air. The incorporation of air thereby causes a corresponding increase in the volume of the liquid or the mixture. The relative density is set, in particular in such a way, that solid particles on the surface of the liquid or mixture sink into it immediately or very quickly and cannot or can hardly be retained by the physical surface tension.

In principle, the incorporation of air can take place in various suitable ways. In particular, an air supply device can be provided by means of which air can be introduced into the liquid or mixture in a finely dispersed manner via one or more supply nozzles.

According to a further development of the invention, it is particularly advantageous that the recirculation line has a port opening which is directed towards an inner side of the mixing trough, wherein the recirculated liquid or mixture impinges on the inner side. During this impingement of the liquid flow, an increase of the surface of the liquid and swirl occurs, wherein embedding of air from the ambient atmosphere is effected.

It is particularly advantageous that a backflow from the recirculation line impinges approximately perpendicularly on the inner side of the mixing trough. Already this flow guidance alone, with an impingement on an inner wall of the mixing trough at approximately a right angle, makes it possible to achieve a desired incorporation of air and a corresponding reduction in relative density.

According to one embodiment variant of the invention, a particularly good integration of air results from the fact that a backflow from the recirculation line, is essentially divided into two partial flows, when it impinges on the inner side of the mixing trough which partial flows flow in opposite directions along the inner side of the approximately drum-shaped mixing trough. The port opening of the recirculation line and the arrangement with respect to the inner side of the mixing trough can be designed in such a way that the backflow is divided into approximately two equal partial flows, which then flow in the circumferential direction along the inner side of the drum-shaped, preferably cylindrical, mixing trough. Thus, a first partial flow flows clockwise along the inner side of the mixing trough and a second partial flow flows in the opposite direction of rotation along the inner side of the mixing trough.

The mixing trough can preferably have a diameter of between 1 meter to 2 meters and be designed to hold a batch of 1 t to 3 t of material/medium. Preferably, 300l to 800l of liquid can be fed at a feed rate of preferably 20 I/s to 100 I/s. The remaining material component, which depends on the formulation, is formed by the one or more solid components, which are added via conveying devices at a feed rate of preferably 10 kg/s to 20 kg/s. Smaller or larger diameters of the mixing trough for deviating batch sizes are also possible in principle.

According to a further embodiment of the invention, it is particularly advantageous that the two partial flows are generated with a flow velocity such that the partial flows meet under formation of swirls at a point of the mixing trough which is approximately opposite to the port opening. The two partial flows flow in opposite directions in each case, around about half the inner circumference of the mixing trough, until the two partial flows meet again and collide. Additional swirl is thus formed in this area, with corresponding increases in the surface area of the partial flows. This promotes the further incorporation of air in finely dispersed form into the respective liquid or mixture.

The liquid or mixture can then sink again inside the mixing trough, the bottom area of which is preferably configured conical, and sink to the mixing device with the rotatingly driven mixing rotor in the area of the outlet opening. The mixing paddles of the mixing rotor are preferably designed and rotationally driven in such a way that cavities are formed in the liquid or mixture in a targeted manner, i, e, short-term cavities with negative pressure. This further supports finely dispersed incorporation of air and also wetting of the solid particles.

The rotating mixing rotor also operates as a kind of pump, by means of which the mixture formed can be discharged from the outlet opening and returned via the recirculation line back again to the upper area of the mixing trough for a further mixing and processing step. As soon as a desired mixing quality has been achieved, which is the case usually after one to two minutes, the recirculation line can be shut-off and the finished mixture can be discharged from the mixing trough as a slurry via the outlet opening by means of a discharge line. The slurry thus formed can then be transported on immediately for further processing or for short-term intermediate storage. A further batch of a slurry can then be formed by introducing at least one liquid and at least one pulverulent solid component.

The colloidal mixer according to the invention is configured to selectively incorporate air in finely dispersed form into the at least one liquid or the mixture in order to reduce a relative density of the liquid or the mixture. The colloidal mixer according to the invention can, in particular be used for performing the above-described method according to the invention. In doing so, the advantages described above can be achieved.

An advantageous further development of the colloidal mixer according to the invention is that the recirculation line has a port opening which is directed towards an inner side of the mixing trough. The recirculated medium can thereby impinge on a drum-shaped inner wall of the mixing trough at a flow velocity which can be several meters per second, preferably 10 m/s to 20 m/s, with this leading to swirl and corresponding incorporation of ambient air.

Alternatively or additionally, according to one embodiment of the invention, it may be provided that an air supply device comprising at least one supply nozzle is arranged for injecting air into the liquid or mixture. The at least one supply nozzle can be provided at any suitable location of the colloidal mixer, in particular in a lower region of the mixing trough. Preferably, a plurality of supply nozzles may be provided, wherein ambient air can be injected under pressure in a finely dispersed manner into the liquid or mixture, in particular in the region of the mixing rotor.

Another preferred embodiment of the invention is that the mixing rotor is arranged in a recess at the bottom of the mixing trough upstream the outlet opening. The mixing rotor with its radially oriented mixing blades can create a desired swirl as well as cavities in the liquid or mixture, due to a corresponding design of the edges and surfaces of the mixing blades. This achieves a particularly good mixing effect. Openings or apertures can be formed in the mixing blades of the rotor to even further improve the mixing effect. At the same time, the mixing rotor can serve as a pump to draw in the liquid or mixture from the upper area of the mixing trough and discharge it at a specified flow rate towards the outlet opening.

According to one embodiment variant of the invention, it is particularly advantageous that the recess having the mixing rotor is arranged centrally or eccentrically at the bottom of the mixing trough relative to the center axis thereof. A central arrangement of the recess with the mixing rotor to a central axis of the mixing trough results in symmetrical flow conditions inside the colloidal mixer. An eccentric arrangement of the mixing rotor to the center axis of the mixing trough can result in an additional swirl effect.

According to a preferred embodiment of the invention, particularly good mixing is achieved in that a rotor axis of the mixing rotor and a center axis of the drum-shaped mixing trough are located in a center plane of the mixing trough, and in that a backflow from the port opening of the recirculation line impinges on the inner side of the mixing trough approximately parallel to the center plane.

The recently developed colloidal or slurry mixer can have a dispersion zone, the actual colloidal mixing device, in which the disintegration of the components takes place, and a convection zone, which holds the actual batch volume, the so-called mixing vessel.

These two zones can be designed with different cylindrical diameters and are preferably connected to one another via an asymmetrical cone.

The dispersion zone can have a tangential outlet which, on the one hand, can be connected by means of a Y-piece to a return or circulation line to the convection zone and on the other hand to a drain line. Both branchings at the Y-piece can preferably be closed and controlled by means of a pneumatic pinch valve depending on the operating state.

Located inside the mixing device is a rotating rotor with special mixing paddles, also called mixing blades. This rotor, preferably driven by a three-phase current motor with toothed belt drive, describes a circular movement at a defined circumferential speed. This leads to motion and force transmission and thus to acceleration of the liquid or liquefied components (such as water, pulverulent solid) located in the mixer.

By way of example, the following operating states can be set:

### Operating State: Mixing

The rotor rotates and the components are accelerated. The circulation line is open while the pinch valve of the discharge or drain line is closed. A defined circulation of the liquid medium located in the system takes place.

### Operating State: Draining

The rotor turns and the components are accelerated. The pinch valve on the recirculation or circulation line is closed and the circulation is stopped. The pinch valve on the drain line is opened. The liquid medium located in the system is pressed into the drain line and discharged from the mixing system.

On the colloidal mixer there is preferably a lid construction with various inlet openings for liquids, solids, additives and, among other things, for the circulation line. A so-called deflecting tube can be attached to the port opening for the circulation line.

In the mixing operating state, the mixing medium circulates between the mixer and the mixing vessel, preferably in a defined volume flow of up to 200 m³/h. The deflecting tube, which is installed in a defined position and inclination, allows the volume flow to be divided into two approximately equal partial flows. This is achieved by deflecting the volume flow to the cylindrical wall of the mixing vessel. The two partial flows move in opposite directions along the cylindrical wall of the mixing vessel and meet opposite the deflecting tube.

The meeting of the two partial flows now causes the backflow to continue centrally in the mixing vessel above the inlet of the mixer and the aspiration of the mixing medium from the mixer is promoted.

At the beginning of each mixing batch, water is first preferably metered into the mixing system as a liquid component. During water metering, the mixing system can already be in the operating state “mixing”. This means that the circulation described above occurs from the beginning on from a certain filling level. Since the resulting volume flow collides with the liquid level from above, a lot of air is now entrained in the liquid (water) and fed to the mixer by means of the created flow.

Due to the high flows, the air cannot escape and now passes through the mixer (dispersion zone) together with the metered water.

Since the mixer generates cavitation due to its technical design, which cavitation was determined by means of a high-speed camera, the air in the water is dispersed particularly finely. This effect supports that the relative density of the dosed water is artificially lowered. This takes place during the entire mixing and metering process for all mixing components.

Evidence of this effect can be considered the fact that the water in the mixing system becomes milky cloudy. If the mixing system is switched off, the water immediately or very quickly deaerates, countless tiny air bubbles rise and the water becomes clear again in a very short time.

If pulverulent mineral solids are now added as a further metering step, the solid can sink more quickly in the water and is thus more easily suctioned by the mixer (dispersion zone).

The cavitation acting in the colloidal mixer now ensures that each individual solid particle is wetted with water and can thus be disintegrated almost optimally. A major positive effect with regard to the metering of mineral solids can be seen, too. Cavitation is caused by the negative pressure generated behind the mixing blades, in which the liquid evaporates, thus creating vapor bubbles. When these bubbles enter a zone of lower pressure, the vapor condenses again and the volume decreases significantly. This creates a brief, extreme pressure difference with respect to the surroundings, so that agglomerates of solid particles, in particular are, as it were, suctioned into the resulting cavity and decomposed. This enables and/or improves the wetting of the individual solid particles with liquid and ensures a particularly homogeneous mixture.

All mineral solids tend to form agglomerates (lumps) in the dry state due to storage or mechanical impacts. Furthermore, mineral solids usually have a bulk density of approx. 1 kg/dm³. Due to this technical fact, solid agglomerates would float on the water surface and could only be poorly influenced or mechanically decomposed into their individual particles by means of flow. By reducing the density of the water according to the invention, the floating of these solid agglomerates is completely prevented or at least considerably reduced.

The solid and agglomerates contained therein are thus fed to the dispersion zone in a targeted manner, where they are disintegrated in a very efficient manner.

Due to the high circulation rate in the mixing system, this also ensures that the entire batch content, consisting of water and solid, passes through the dispersion zone multiple times, and thus a very good homogenization takes place.

According to the invention, an advantageous embodiment of the colloidal mixer is that the mixing rotor has mixing blades which are provided with a hole pattern. The mixing blade is preferably formed from a base plate, wherein a plurality of through holes are formed in the base plate by the hole pattern, preferably by means of machining, (laser) cutting or punching. Preferably, the holes of the hole pattern may have a circular contour in whole or in part. The holes may have a diameter of between 5 mm and 50 mm and, in particular, may be arranged in a grid with uniform grid spacing. Other hole sizes and in particular other hole contours, such as angular or polygonal, are possible.

The hole pattern in the mixing blades results in a significant increase in the effective flow edges on the mixing blade. This increases the effect of swirl and, in particular also the formation of relatively small cavities in a large number. Preferably, the hole pattern with the through holes can form a total opening area which accounts for between 25% to 35%, particularly preferably between 26% to 28%, of the total area of the mixing blade. The ratio of the effects of flow edge length to flow resistance is most favorable in this case. In particular, the holes are located in the lower approximately 65%, preferably 62% to 66%, of the blade height. The dimensions of the mixing blades are based on the dimensions of the recess or receptacle in the mixer, with marginal edges of the mixing blades extending as close as possible to the wall. The mixing blade can preferably be approximately rectangular in design and, in particular, have a width of 50 mm to 400 mm and a height of 150 mm to 700 mm. Other dimensions are possible depending on the shape of the mixer.

Another positive effect resides in that the change in flow resistance reduces the energy required for rotationally driving the mixing rotor at a predetermined rotational speed. Thus, an improvement of the mixing and homogenization effect of the colloidal mixer can be achieved with a reduced energy requirement. The mixing rotor can preferably be driven at a rotational speed between 100 rpm to 800 rpm. Deviations are possible with regard to the formulation of the mixture.

The mixer and/or the mixing blades can preferably be formed from a resistant stainless steel, in particular a Hardox material.

The invention is described in greater detail below with reference to a preferred exemplary embodiment, which is shown schematically in the accompanying drawings. The drawings show in:

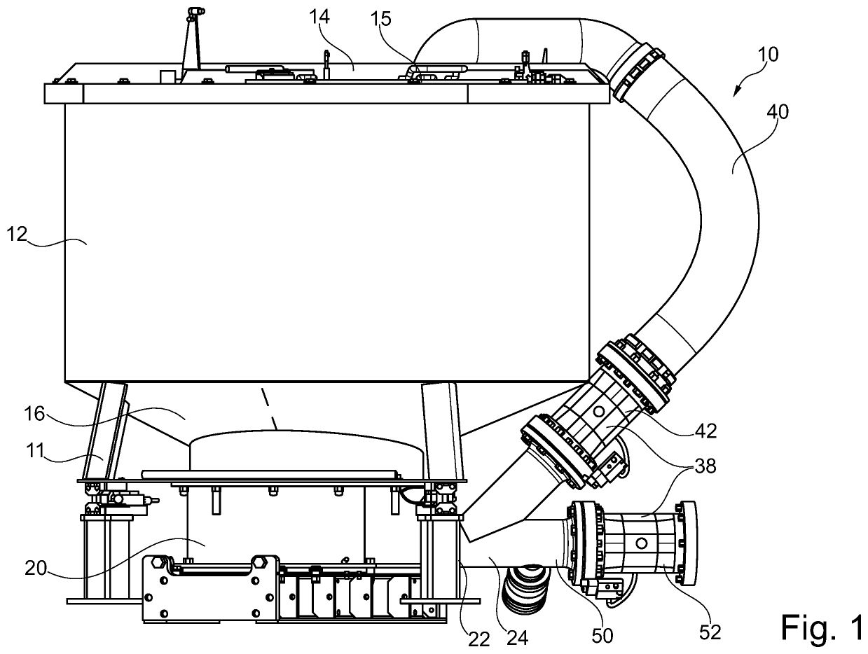

FIG. 1 a side view of a colloidal mixer according to the invention;

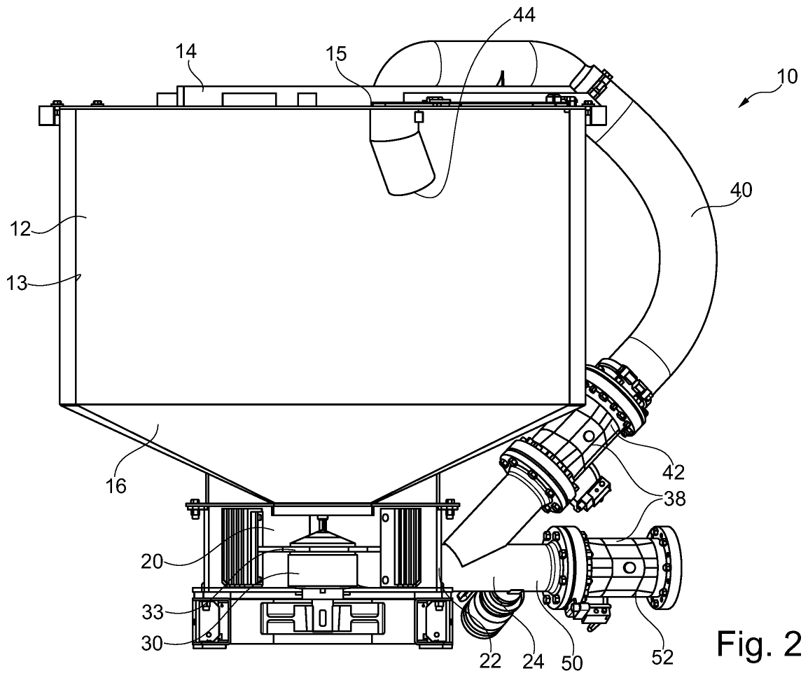

FIG. 2 a cross-sectional view through a colloidal mixer according to the invention according to FIG. 1;

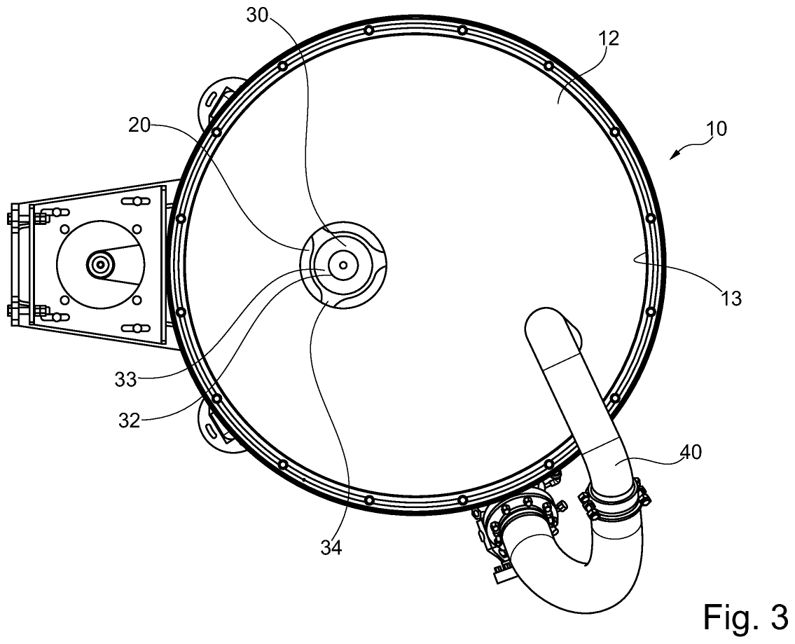

FIG. 3 a top view of the colloidal mixer of FIG. 1, but without lid;

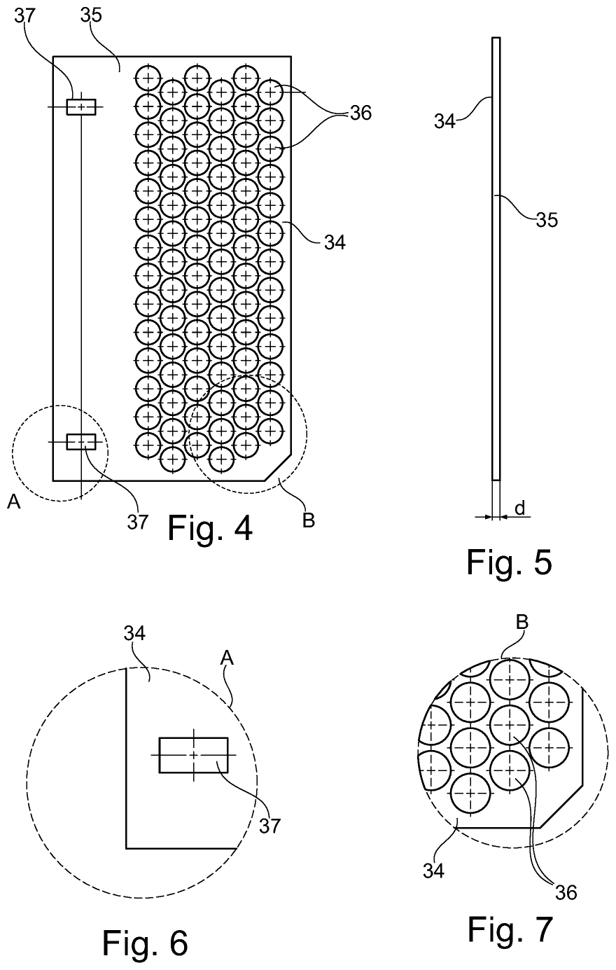

FIG. 4 an enlarged illustration of a mixing blade in a side view with a hole pattern;

FIG. 5 a frontal view of the sheet metal-type mixing blade of FIG. 4;

FIG. 6 an enlarged illustration of detail A of FIG. 4; and

FIG. 7 an enlarged illustration of detail B of FIG. 4.

FIGS. 1 to 3 show an exemplary embodiment of a colloidal mixer 10 according to the invention with a drum-shaped mixing trough 12, which is arranged on a frame 11. The drum-shaped mixing trough 12 has a cylindrical inner surface 13 or inner wall in its upper portion, and is closed at its upper surface by a lid 14. A lower portion of the mixing trough 12 is formed by a conically configured bottom 16, which merges via an opening into a downwardly directed receptacle or recess 20 with a mixing device 30. The opening having the recess 20 is arranged eccentrically to a center axis of the cylindrical upper section of the mixing trough 12, as can be seen clearly in FIG. 3.

The mixing device 30 in the recess 20 on the underside of the mixing trough 12 has a rotationally driven mixing rotor 32 with a rotor hub 33 and radially oriented mixing blades 34 attached thereto. Altogether, the mixing rotor 32 with the mixing blades 34 is configured such that at least one liquid component introduced into the mixing trough 12 is mixed with at least one pulverulent solid component supplied into the mixing trough 12 by means of the rotating mixing rotor 32. In this case, a circumferential speed of the mixing rotor 32 is set in such a way and the shape of the mixing blades 34 is designed in such a way that cavities are formed in a targeted manner in the at least one liquid or the mixture forming, which further support a mixing effect and a fine distribution of air.

The at least one liquid or the forming mixture is discharged by means of the rotationally driven mixing rotor 32 to a lateral outlet opening 22 with a Y-pipe section 24, at the two outlet connections of which a backflow line 40 on the one hand and a discharge line 50 on the other hand are arranged. An actuator 38 can be used to control whether the mixture formed is returned to the mixing trough 12 via the backflow line 40 for continuation of the mixing process or is discharged from the colloidal mixer 10 via the discharge line 50.

For forming the actuator 38, a first pinch valve 42 is arranged on the backflow line 40 and a second pinch valve 52 is arranged on the discharge line 50, which can be closed or opened in particular by supplying a pressure medium, in particular compressed air.

When the first pinch valve 42 is open and the second pinch valve 52 is closed, liquid or mixture is returned again from the Y-pipe section 24 to an upper portion of the mixing trough 12 via the backflow line 40 through a feed opening 15 in the lid 14, as illustrated clearly in FIGS. 2 and 3.

In this case, the free end of the backflow line 40 has a deflecting tube or port opening 44, which is directed towards the inner side 13 of the mixing trough 12. As a result of the of the liquid or mixture exiting the port opening 44 and impinging on the inner side 13 of the mixing trough 12, ambient air is finely dispersed incorporated in the liquid or mixture. This is supported by the fact that the backflow is divided into two partial flows by the orientation of the port opening 44, which flow along the inner side 13 of the mixing trough 12 in opposite directions in the circumferential direction. At a flow velocity of several meters per second, the partial flows can thus meet again in an opposite area on the inner side 13 of the mixing trough 12, wherein further air is incorporated into the liquid or mixture by additional swirl.

The incorporation and fine distribution of the air is further increased by the rotating motion of the mixing rotor 32 with the mixing blades 34, as already described above. The mixing process can preferably last between 100 seconds to 200 seconds.

Once a desired consistency or homogeneity of the mixture has been achieved, the first pinch valve 42 on the backflow line 40 can be closed and the second pinch valve 52 on the discharge line 50 can be opened. In this manner, the ready formed mixture or slurry is discharged from the colloidal mixer 10 through the discharge line 50 and out of the outlet opening 22 by the pumping action of the mixing device 30.

After emptying the mixing trough 12, another mixing process for a new batch can be started.

FIGS. 4 to 7 show a possible embodiment for a mixing blade 34, which can be used on a mixing rotor 32 of a mixing device 30 of the colloidal mixer 10 described above.

For fastening the mixing blade 34 to a rotor hub 33 of the mixing rotor 32, fastening elements 37 are shown schematically on one fastening side. These elements serve for detachable fastening of the mixing blade 34 to the rotor hub 33. FIG. 6 shows detail A with the fastening element 37 of FIG. 4 in greater detail.

The mixing blade 34 is formed from a base metal sheet 35 with a thickness d, as can clearly be discerned in FIG. 5. The thickness d can range from 3 mm to 20 mm. A hole pattern 36 having a plurality of through holes is formed in the actual mixing region of the mixing blade 34. The side surfaces of the mixing blade 34 can be surface treated.

A diameter of the through holes can range between 5 mm and 50 mm. The material webs located between the through holes may have a size of a few mm. Overall, the hole pattern 36 with the through holes may form a total opening area which accounts for between 40% to 80% of the total face of the mixing blade 34.

FIG. 7 shows a partial area of the hole pattern 36 in greater detail, wherein the hole pattern 36 is formed from a plurality of through holes arranged in rows next to one another in a grid. Grid or material webs with corresponding flow edges remain between the through holes, which ensure for good swirl and a particularly finely distributed formation of cavities over the surface of the mixing blade 34. In principle, a web width between the holes can be between 10% and 40%, preferably between 16% and 33%, of the hole diameter. Here, a sheet thickness may be between 20% to 75%, preferably between 33% to about 66%, of the hole diameter. Preferably, the hole diameter is between 10 mm to 20 mm, more preferably about 12 mm.

Referring to FIG. 7, a lower corner portion of the mixing blade 34 may be chamfered or angled.

1. A method for the colloidal processing of a slurry, in particular processing of construction materials, using a colloidal mixer, in which
at least one liquid is introduced into a mixing trough, at the lower region of which is arranged an outlet opening with a mixing device having a mixing rotor which is driven in rotation,
at least one pulverulent solid component is introduced into the mixing trough,
the at least one liquid is mixed with the at least one pulverulent solid component by means of the rotationally driven mixing rotor, is induced to flow, and is discharged from the mixing trough through the outlet opening,
wherein the mixture is returned again for a certain time via a flowback line to an upper region of the mixing trough for further mixing, and
after reaching a desired mixing state, the mixture is discharged as a finished slurry from the outlet opening by means of a discharge line,
wherein
air is incorporated into the at least one liquid and/or the mixture in finely dispersed form in a targeted manner, wherein a relative density of the liquid, or of the mixture, is reduced.

2. Method according to claim 1,
wherein
the relative density of the at least one liquid or the mixture is reduced, wherein the volume of the liquid or of the mixture is increased by 2 percent to 15 percent by supplying air.

3. Method according to claim 1,
wherein
the backflow line comprises a port opening which is directed towards an inner side of the mixing trough, wherein the led back liquid or mixture impinges on the inner side.

4. Method according to claim 3,
wherein
a backflow from the backflow line impinges approximately perpendicularly on the inner side of the mixing trough.

5. Method according to claim 3,
wherein
a backflow from the backflow line is essentially divided into two partial flows when it impinges on the inner side of the mixing trough, which partial flows flow in opposite directions along the inner side of the approximately drum-shaped mixing trough.

6. Method according to claim 5,
wherein
the two partial flows are generated with a flow velocity such that the partial flows meet, along with a formation of swirls, at a point of the mixing trough which is approximately opposite to the port opening.

7. Colloidal mixer for the colloidal processing of a slurry, in particular for the processing of construction materials and in particular for performing a method according to claim 1, comprising
a mixing trough which comprises an upper feed opening for feeding at least one liquid and at least one pulverulent solid component and a lower outlet opening,
a mixing device which comprises a mixing rotor which can be driven in rotation and is arranged in a lower region of the mixing trough, wherein the at least one liquid and the at least one pulverulent solid component are mixed by the mixing rotor into a mixture and a flow of the at least one liquid or of the mixture can be generated towards the outlet opening,
a backflow line which extends from the outlet opening back again to the upper feed opening of the mixing trough,
a discharge line for discharging a finished slurry from the mixing trough, and
a control valve device by means of which the backflow line and the discharge line can be opened or closed, in particular alternately,
wherein
the colloidal mixer is configured to incorporate air in finely dispersed form into the at least one liquid, or the mixture, in a targeted manner in order to reduce a relative density of the liquid, or of the mixture.

8. Colloidal mixer according to claim 7,
wherein
the backflow line comprises a port opening which is directed towards an inner side of the mixing trough.

9. Colloidal mixer according to claim 7,
wherein
an air supply device comprising at least one supply nozzle is arranged for injecting air into the liquid or mixture.

10. Colloidal mixer according to claim 7,
wherein
in that the mixing rotor is arranged in a recess at the bottom of the mixing trough upstream the outlet opening.

11. Colloidal mixer according to claim 10,
wherein
in that the recess with the mixing rotor is arranged centrally or eccentrically on the bottom of the mixing trough relative to the center axis thereof.

12. Colloidal mixer according to claim 7,
wherein
a rotor axis of the mixing rotor and a center axis of the drum-shaped mixing trough are located in a center plane of the mixing trough and, in that a backflow from the port opening of the backflow line impinges on the inner side of the mixing trough approximately parallel to the center plane.

13. Colloidal mixer according to claim 7,
wherein
the mixing rotor comprises mixing blades which are provided with a hole pattern.
